(19) United States
(12) Patent Application Publication
(10) Pub. No.: US 2013/0233878 A1
(43) Pub. Date: Sep. 12, 2013

(54) DISPENSING UNIT AND METHOD FOR DISPENSING A LIQUID UNDER PRESSURE

(71) Applicant: István Stephen Lindmayer, Dobrokoz (HU)

(72) Inventor: István Stephen Lindmayer, Dobrokoz (HU)

(73) Assignee: HEINEKEN SUPPLY CHAIN B.V., Amsterdam (NL)

(21) Appl. No.: 13/700,821

(22) PCT Filed: May 27, 2011
(86) PCT No.: PCT/NL2011/050368

§ 371 Date: May 29, 2013

(30) Foreign Application Priority Data
Jun. 2, 2010 (HU) P1000286

(51) Int. Cl. B67D 1/12

(52) U.S. Cl. CPC B67D 1/1202
USPC 222/1; 222/396; 222/399; 222/212

(57) ABSTRACT

A dispensing unit for dispensing a liquid under pressure, the dispensing unit comprising a first coupling means for coupling to a liquid container adapted to store the liquid to be dispensed and a propellant gas at a first pressure and a pressure regulating means for generating said first pressure in the liquid container. The pressure regulating means have a second coupling means for coupling to a gas container adapted to store said propellant gas at a second pressure substantially higher than said first pressure and a first fluid communication path for the propellant gas between said gas container and said liquid container. Furthermore a dispensing path for dispensing the liquid from the liquid container and a first operating means for controlling the flow rate of the liquid along the liquid dispensing path during dispensing are provided. The dispensing unit further comprises a second operating means for controlling, during dispensing, the pressure of the liquid container within a range defined by the first pressure and a third pressure lower than the first pressure.

The present invention relates to a dispensing unit and a method for dispensing a liquid under pressure.

The document EP 1064221 discloses a device for dispensing a liquid, wherein the device comprises a container having a first compartment, and a second compartment, the first compartment being arranged for receiving the liquid to be dispensed, and the second compartment being arranged for receiving a propellant gas, wherein, at least during use, an opening is provided between the first and the second compartment. The device further comprises a pressure control means arranged for controlling, during use, the pressure of the propellant gas flowing from the second compartment into the first compartment. The pressure in the second compartment, at least prior to use, is between 4 and 16 bar, preferably about 10 bar, measured at application temperature, whereas the regulated pressure in the first compartment, at which the liquid is dispensed via the dispensing means, is such that an overpressure of 0.1 to 1.5 bar, preferably about 0.7 bar, relative to the surroundings is maintained in the first compartment. This device has the drawback that the pressure in the first compartment is regulated so that a constant pressure is always maintained therein, which means that in case of gaseous beverages, where an overpressure of about 0.6-0.8 bar should be maintained depending on the equilibrium pressure of the particular beverage, a substantial overpressure prevails in the first compartment during dispensing the liquid. The flow rate of the liquid during dispensing can be controlled solely by adjusting the cross-sectional flow area of a dispensing duct or outlet of the dispensing device. Decreasing the flow area of the liquid at a constant pressure, however, results in an increase of the flow velocity of the liquid, which may cause the development of undesired turbulences in the liquid in the region of the restricting member. This leads to excess frothing of the dispensed liquid and, in particular for gaseous beverages, a substantial release of gas from the liquid.

The present invention is based on the inventive idea that during dispensing, instead of maintaining a regulated constant pressure in the liquid container and controlling the flow rate of the liquid by controlling the flow area of the dispensing channel or dispensing outlet for the liquid, the flow area of the dispensing channel or outlet is rather maintained at a constant value, preferably at a maximum value, and the pressure in the liquid container is controlled within a predetermined pressure range so as to control the flow rate of the liquid being dispensed. This novel approach of dispensing allows to apply a relatively low pressure at dispensing for any kind of liquid, including both gaseous and non-gaseous beverages, while keeping the possibility to adjust the flow rate of the liquid by simply adjusting (or even varying) the desired pressure of the propellant gas in the liquid container. A further advantage of this solution is that by controlling the pressure prevailing in the liquid container during dispensing, the flow path of the liquid from the liquid container through the dispensing unit may be formed free of any obstacle of flow, thus allowing to avoid the development of undesired turbulences in the liquid during dispensing.

It is therefore an object of the present invention to provide a dispensing unit adapted for adjusting the pressure of the propellant gas in the liquid container by the consumer during dispensing within a predetermined range of pressure. Another object of the present invention is to provide a dispensing unit adapted to establish a predetermined regulated pressure for storing the liquid in the container after dispensing.

It is yet another object of the present invention to provide a method for dispensing a liquid at a low and adjustable pressure.

These and other objects are achieved by providing a dispensing unit as defined in claim 1. The above objects are further achieved by providing a method as defined in claim 12. Preferred embodiments of the dispensing unit and the method according to the present invention are defined by the dependent claims.

The present invention will now be described in more detail through preferred embodiments thereof with reference to the accompanying drawings, in which:

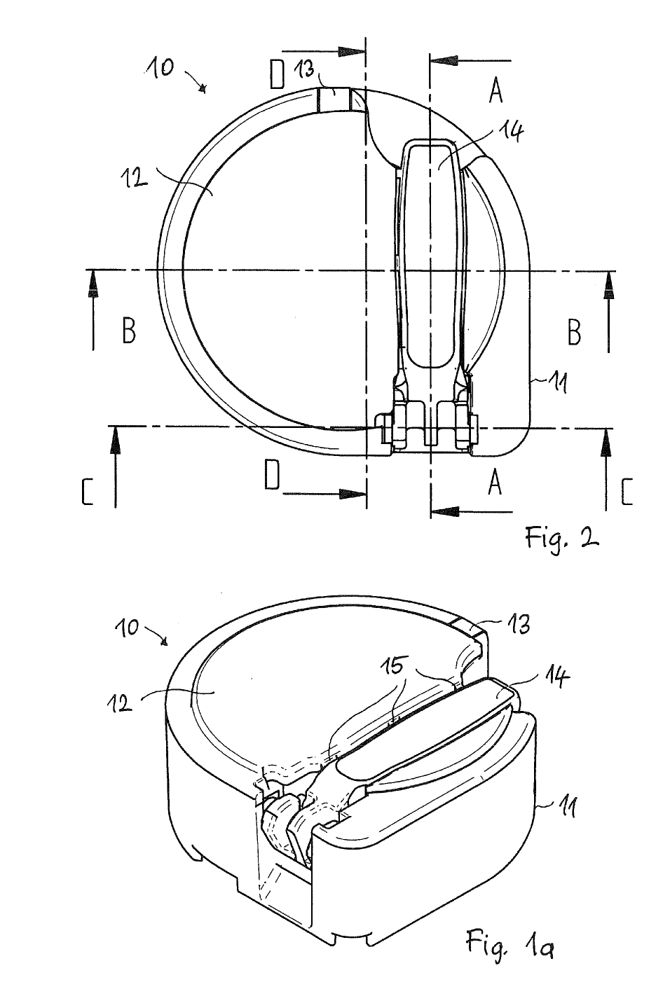

FIG. 1a is a perspective view of a first preferred embodiment of the dispensing unit according to the invention in its initial state,

FIGS. 1b, 1c and 1d are a top plan view, a side view and a bottom plan view of the dispensing unit shown in FIG. 1a, respectively, in an unfolded state,

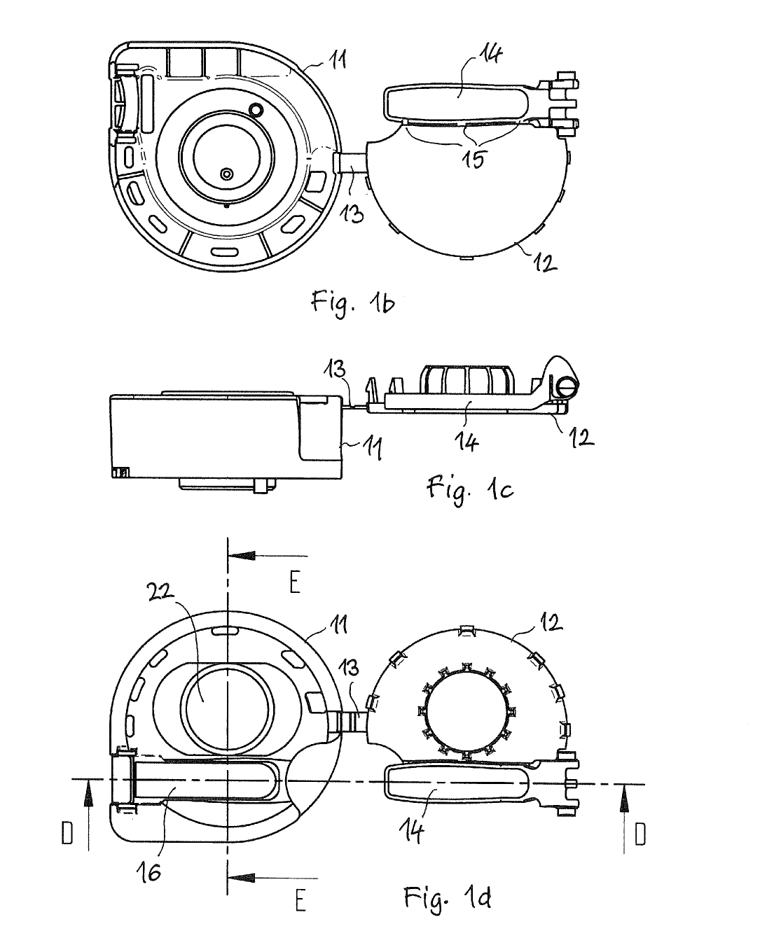

FIG. 2 is top plan view of the dispensing unit shown in FIG. 1 in its initial state,

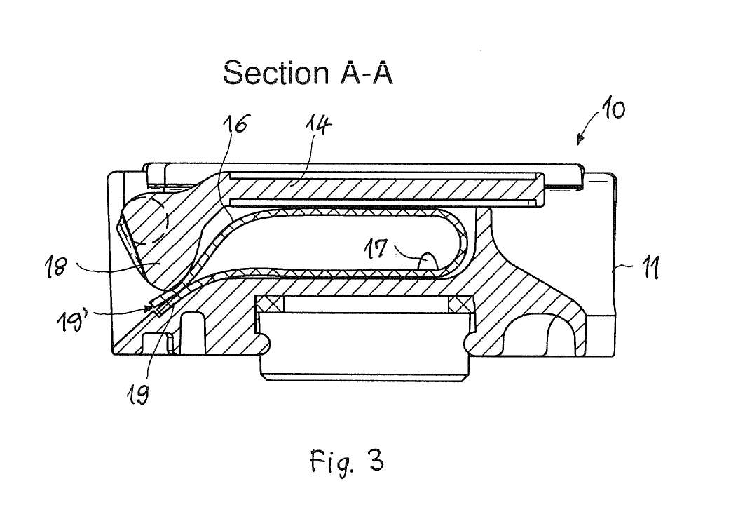

FIG. 3 is a cross sectional view of the dispensing unit shown in FIG. 1 taken along the line A-A,

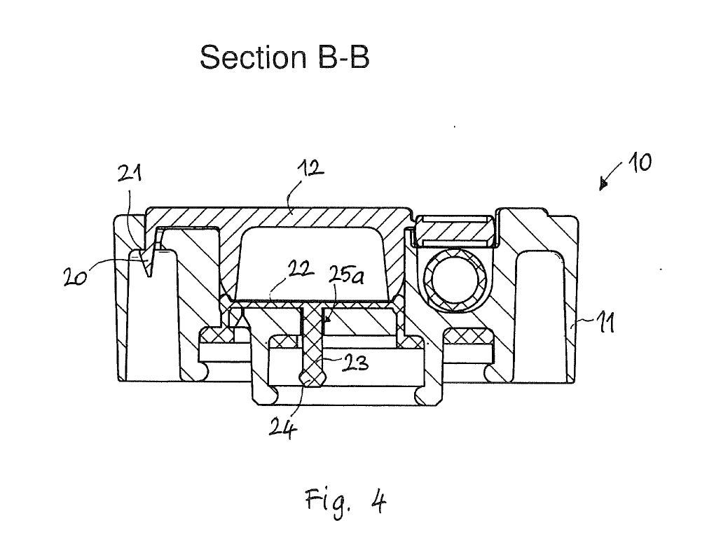

FIG. 4 is a cross sectional view of the dispensing unit shown in FIG. 1 taken along the line B-B,

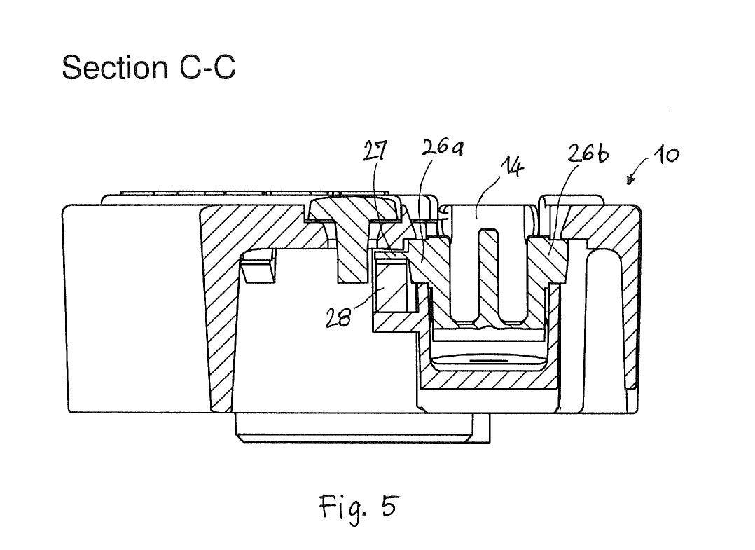

FIG. 5 is a cross sectional view of the dispensing unit shown in FIG. 1 taken along the line C-C,

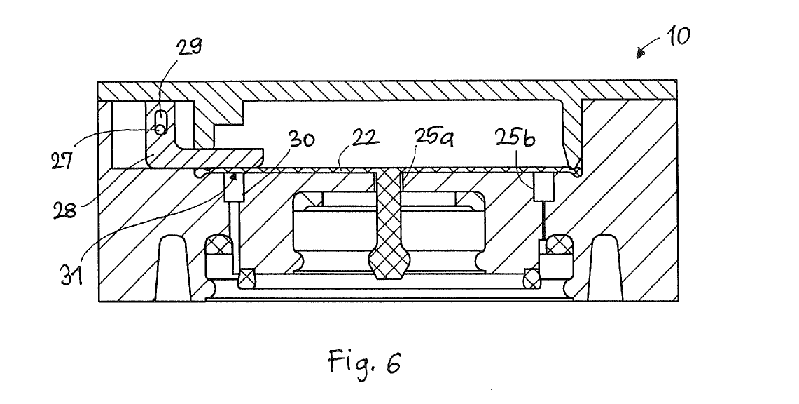

FIG. 6 is a cross sectional view of the dispensing unit shown in FIG. 1 taken along the line H-H,

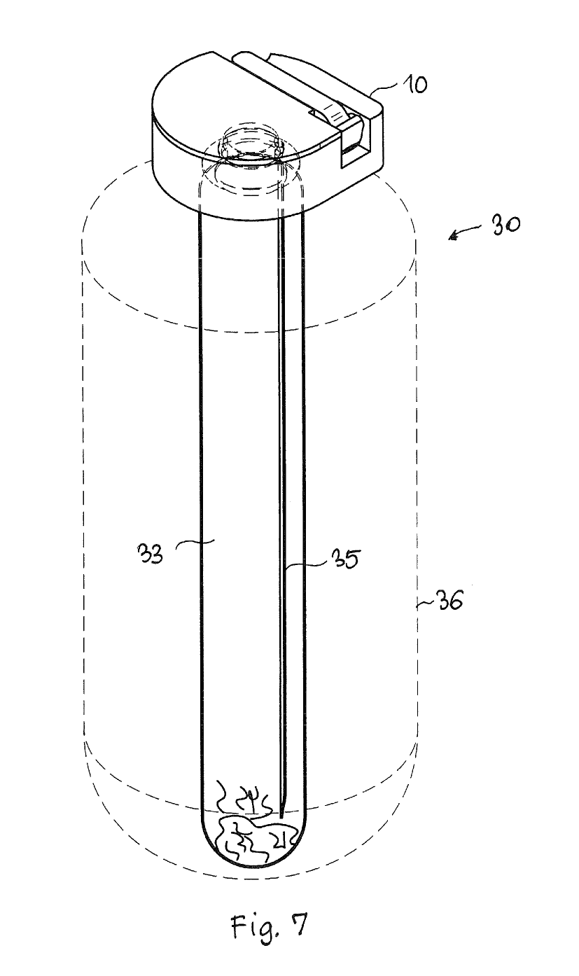

FIG. 7 is perspective view of a dispensing device comprising the dispensing unit shown in FIG. 1,

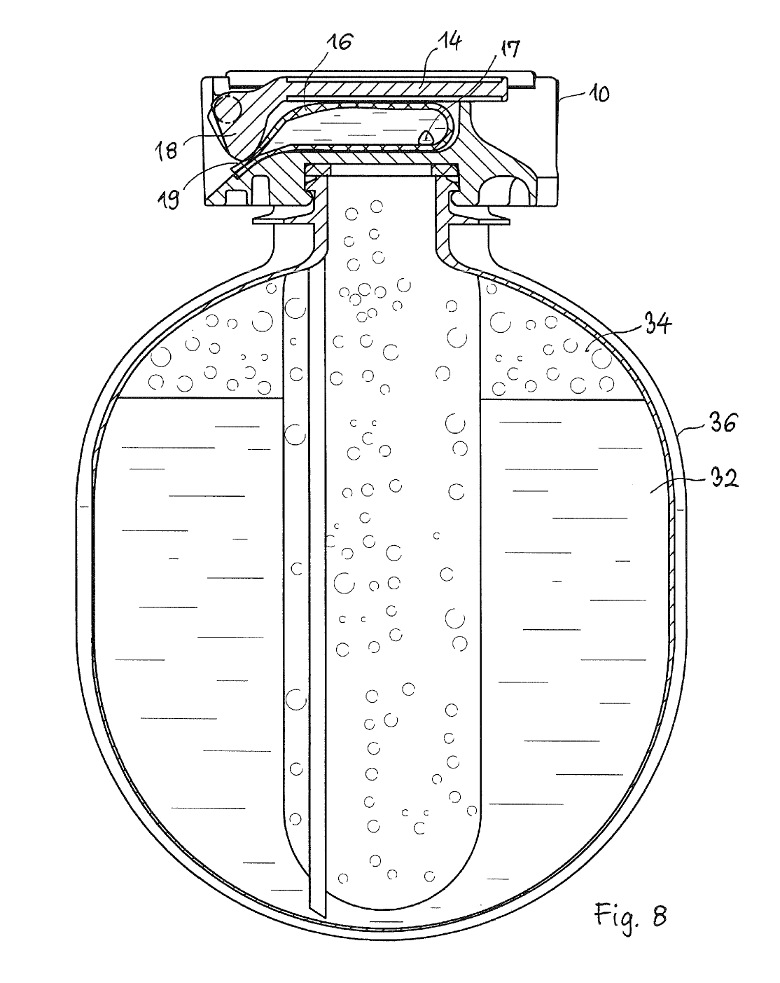

FIG. 8 is a cross-sectional view of the dispensing device shown in FIG. 7 taken along the line A-A of FIG. 2, with the operating lever being in its initial position,

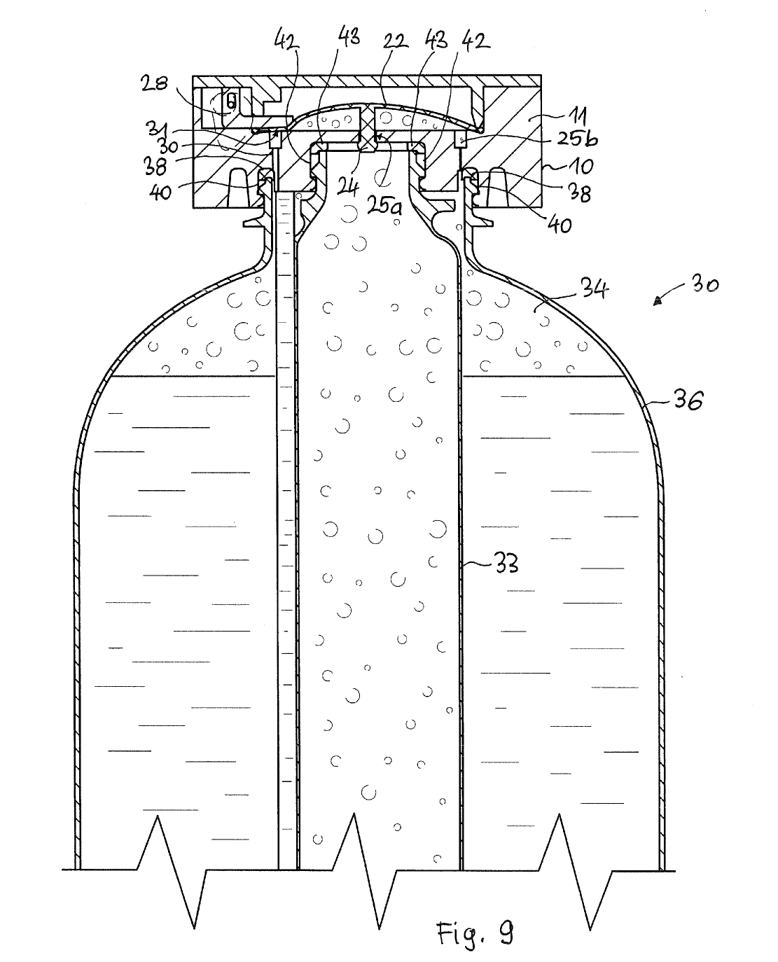

FIG. 9 is a partial cross-sectional view of the dispensing device shown in FIG. 7 taken along the line H-H of FIG. 2, with the operating lever being in its initial position,

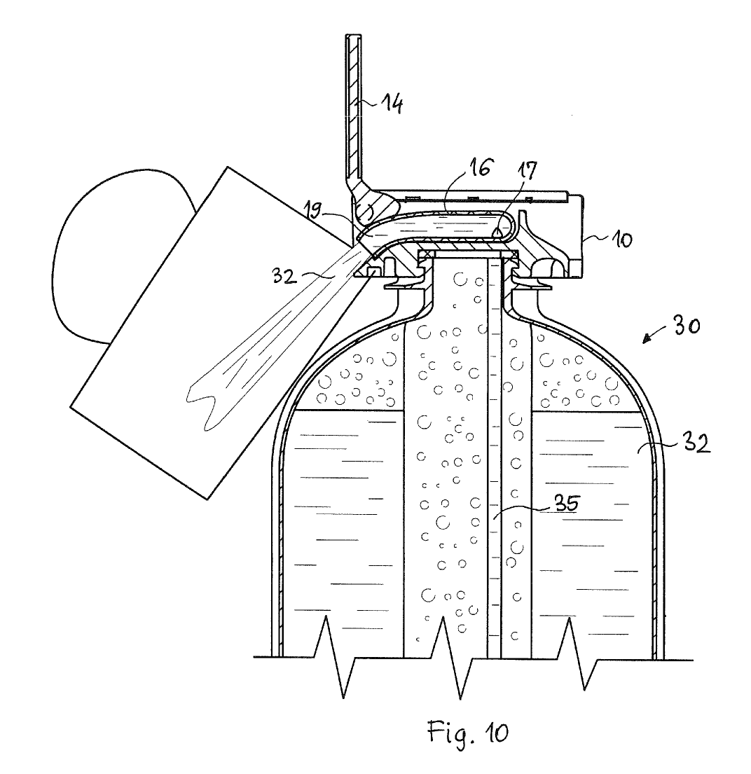

FIG. 10 is a partial cross-sectional view of the dispensing device shown in FIG. 7 taken along the line A-A of FIG. 2, with the operating lever being in a first operating position,

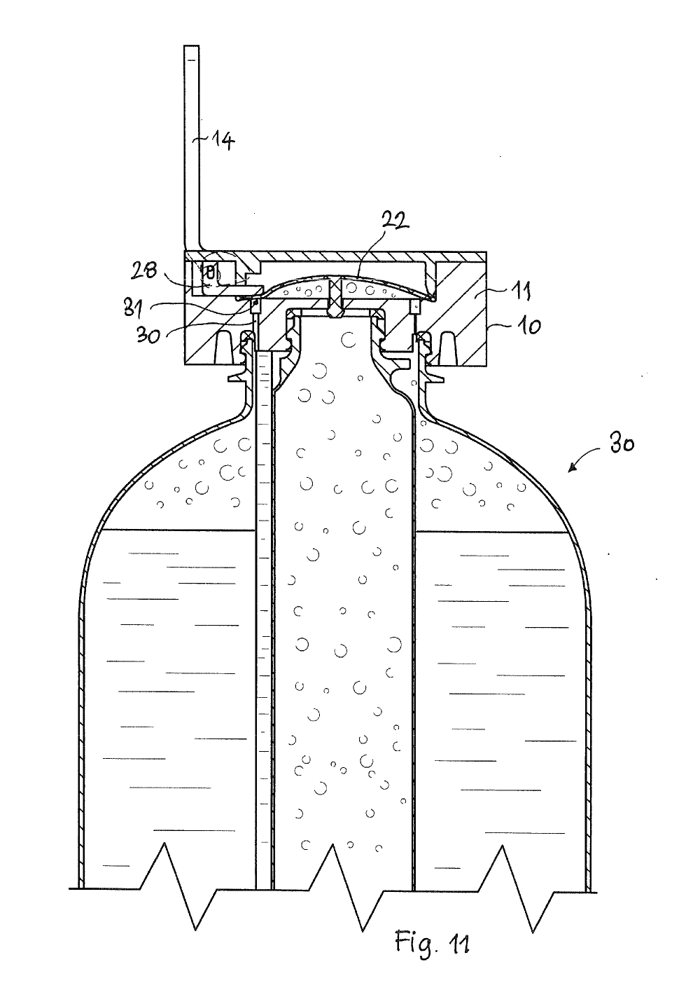

FIG. 11 is a partial cross-sectional view of the dispensing device shown in FIG. 7 taken along the line H-H of FIG. 2, with the operating lever being in the first operating position,

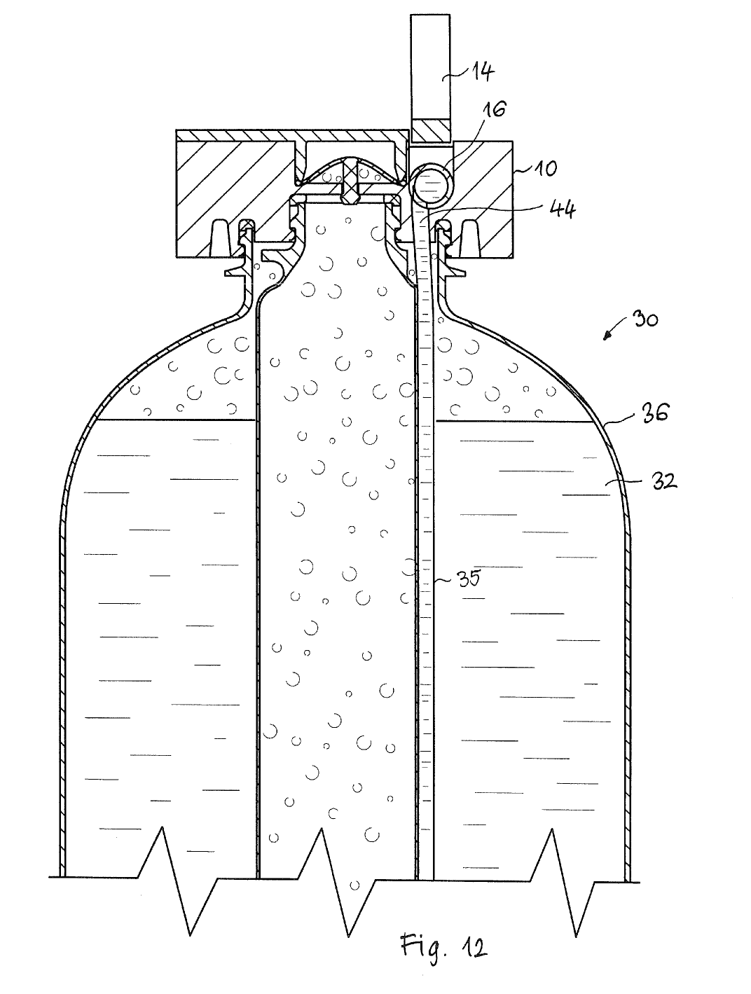

FIG. 12 is a partial cross-sectional view of the dispensing device shown in FIG. 7 taken along the line G-G of FIG. 2, with the operating lever being in the first operating position,

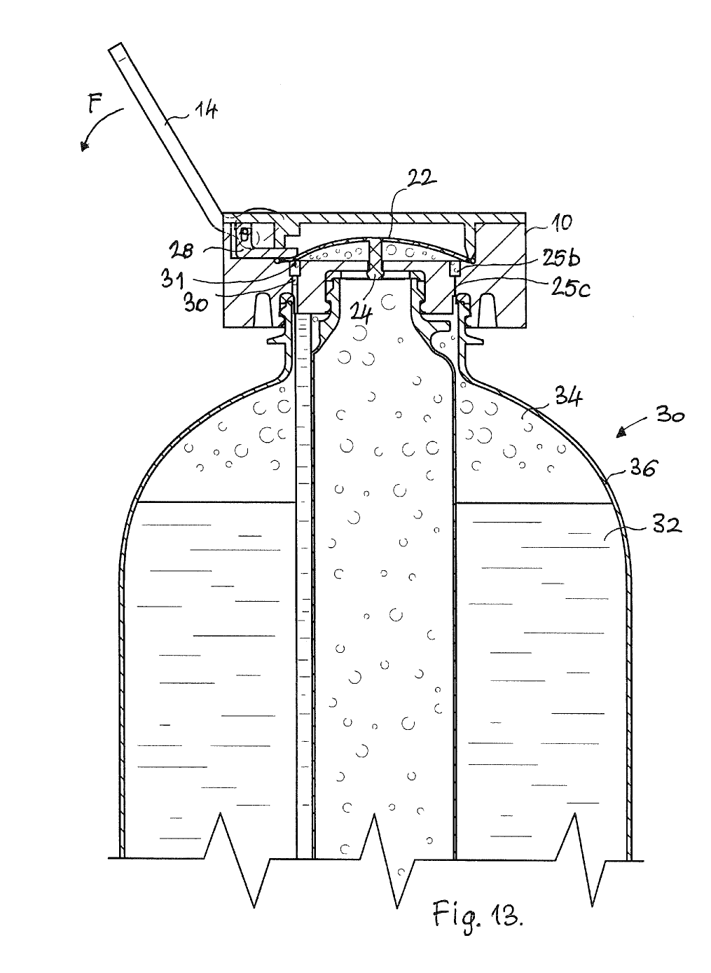

FIG. 13 is a partial cross-sectional view of the dispensing device shown in FIG. 7 taken along the line H-H of FIG. 2, with the operating lever being in a second operating position,

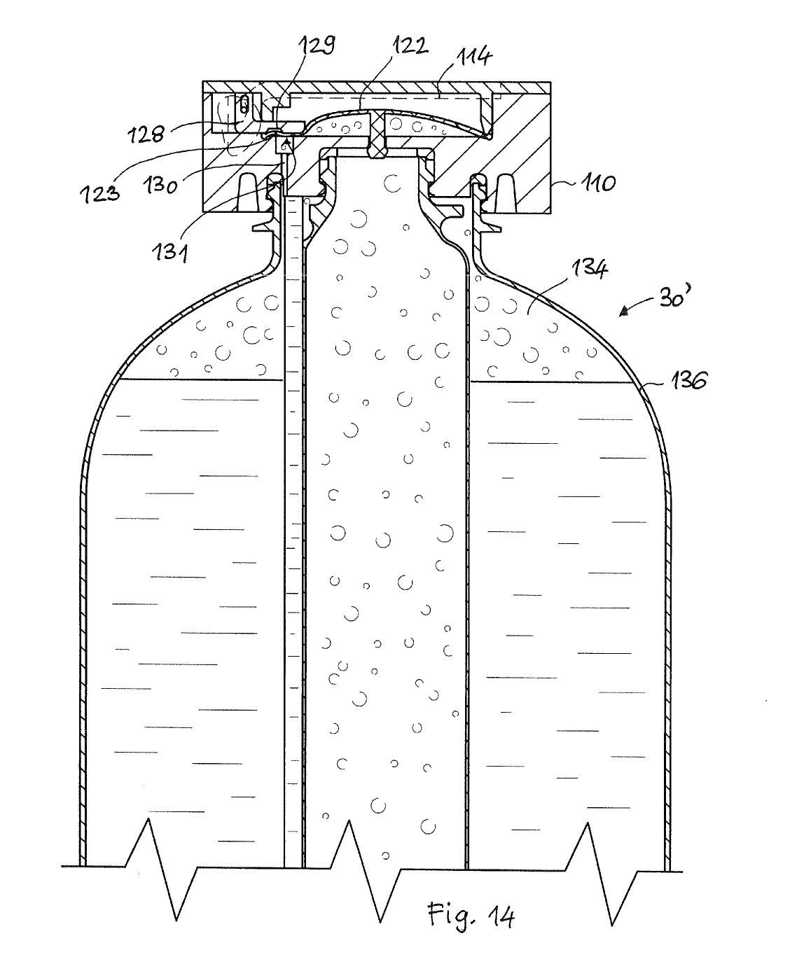

FIG. 14 is a partial cross-sectional view of the dispensing device shown in FIG. 7 taken along the line H-H of FIG. 2, showing a second embodiment of the dispensing unit with the operating lever being in the initial position,

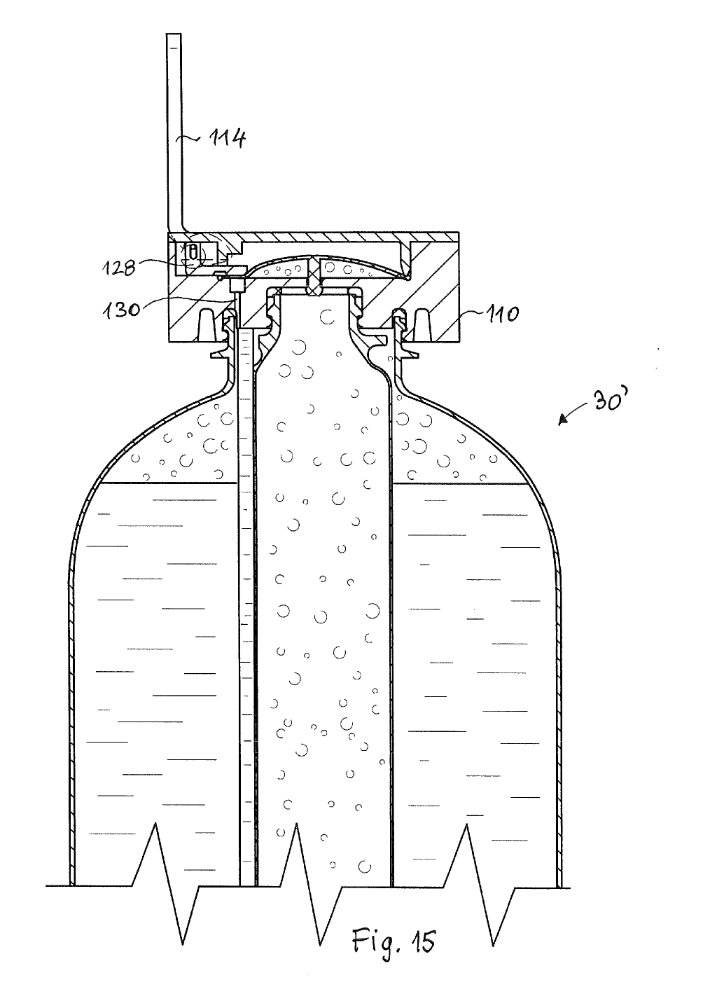

FIG. 15 is a partial cross-sectional view of the dispensing device shown in FIG. 7 taken along the line H-H of FIG. 2, showing the second embodiment of the dispensing unit with the operating lever being in its first operational position, and

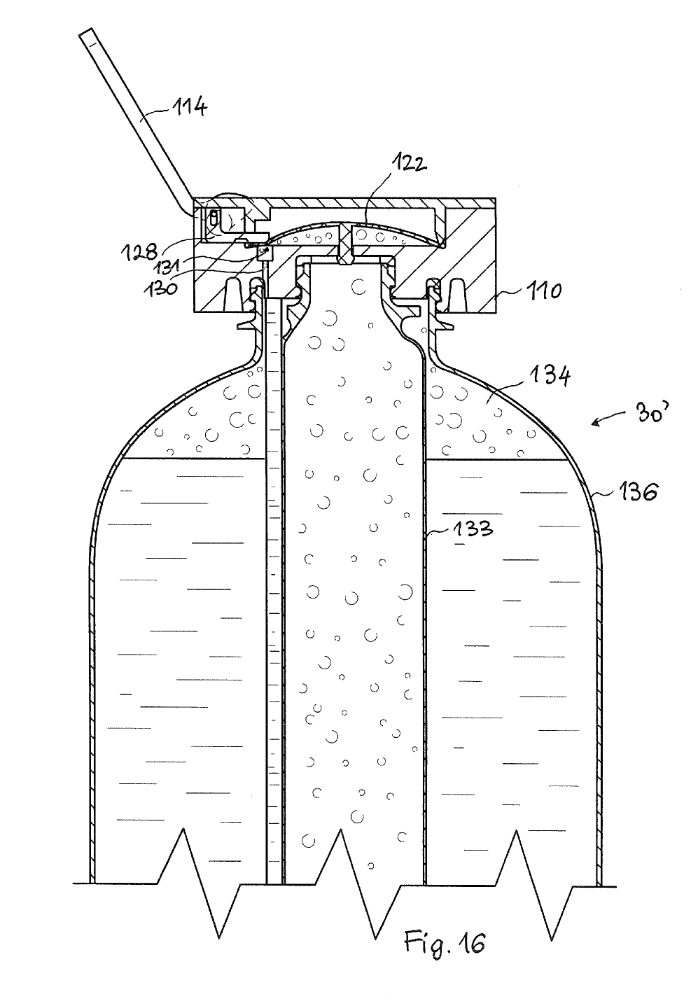

FIG. 16 is a partial cross-sectional view of the dispensing device shown in FIG. 7 taken along the line H-H of FIG. 2, showing the second embodiment of the dispensing unit with the operating lever being in its second operating position.

In FIG. 1a, a first preferred embodiment of the dispensing unit 10 according to the invention is illustrated in a perspective view. Although the dispensing unit 10 in FIG. 1 is shown as a cap for a bottle, the dispensing unit may be designed in any other way, for example as a taping unit for a beer keg. The illustrated first embodiment of the dispensing unit 10 comprises a lower mounting part 11 and an upper covering part 12. The lower mounting part 11 and the upper covering part 12 are connected via a flexible hinge 13. The upper covering part 12 comprises a pivotable operating lever 14 used to control the flow rate of the liquid during dispensing. The operating lever 14 is provided with several once breakable joints 15 for fixing the operating lever 14 to an adjacent portion of the upper covering part 12. These joints 15 also have the function to demonstrate that the dispensing unit 10 has not been tampered with. Before the first use of the dispensing unit 10, these joints 15 are to be broken so that the operating lever 14 can be moved.

In FIGS. 1a, 1b and 1c, the lower mounting part 11, the upper covering part 12, the operating lever 14 and the once breakable joint 15 of the dispensing unit 10 can be seen in different views of an unfolded state. In FIG. 1d, a flexible dispensing tube 16 and a membrane 22 of a pressure regulating means are also shown, although these elements are arranged inside the dispensing unit 10.

In FIG. 2, the dispensing unit 10 can be seen in a plan view using the same reference numbers as in FIGS. 1a to 1d. This figure also indicates sectioning lines A-A, B-B, C-C and H-H along which cross-sectional views are taken and illustrated in the following FIGS. 3 to 6, in which the dispensing unit 10 is shown in its initial state, i.e. in the storage state, when the operating lever is in its initial position.

FIG. 3 illustrates the dispensing unit 10 in a cross-sectional view taken along the line A-A indicated in FIG. 2. Inside the dispensing unit 10, a dispensing tube 16 is arranged under the operating lever 14. The dispensing tube 16 is secured to the lower mounting part 11 and comprises an opening 17 that establishes a fluid communication with the internal space of the liquid container (not shown) to which the dispensing unit 10 is coupled. The dispensing tube 16 has an outer end portion 19 provided with an opening 19′ to allow the liquid to flow out from the liquid container during dispensing. In FIG. 3, the outer end portion 19 of the dispensing tube 16 is entirely compressed by an eccentric front projection 18 of the operating lever 14, thereby the flow path of the liquid is closed.

As can be seen in FIG. 4, the upper covering part 12 of the dispensing unit 10 is secured to the lower mounting part 11, for example, by snap fitting between a downward projection 20 of the upper covering part 12 and the rim 21 of a corresponding through-hole of the lower mounting part 11 adapted to receive said projection 20.

The dispensing unit 10 also comprises a pressure regulating means to generate a constant regulated pressure for the propellant gas in the liquid container. In the illustrated preferred embodiments of the dispensing unit 10, the pressure regulating means comprises a resilient membrane 22, preferably made of rubber, a valve stem 23 joined to a central portion of the membrane 22 at is one end, a valve head 24 formed at the other end of the valve stem 23 and a fluid communicating path for the propellant gas, said fluid communicating path connecting the internal space of the gas container and the internal gas space of the liquid container (also referred to as head space) through the pressure regulating means. In the illustrated embodiments of the dispensing unit 10, the fluid communicating path includes a first gas channel 25a in which the valve stem 23 is guided, and a second gas channel 25b (shown in FIG. 6). The operation of the pressure regulating means of the dispensing unit 10 will be described later.

As shown in FIG. 5, the operating lever 14 has two coaxial pivots 26a and 26b serving as a shaft for the operating lever 14 around which it can be pivoted. On the lateral surface of the inner pivot 26a, there is a stud 27 arranged extending into a guiding hole 29 (shown in FIG. 6) of a slide 28. The slide 28 is guided so that it can move horizontally between two end positions defined by the two end positions of the operating lever 14. When the operating lever 14 is pivoted, the stud 27, which is arranged eccentrically with respect to the rotational axis of the pivots 26a, 26b, moves along a circular path, thus forcing the slide 28 to move toward the central portion of the dispensing unit 10 or in the opposite direction, while the stud 27 moves up or down in the guiding hole 29.

As clearly shown in FIG. 6, the slide 28 partly covers the membrane 22, the extent of coverage depending on the position of the operating lever. Under the coverage area of the membrane 22, there is a third gas channel 30 formed to connect the internal space of the gas container with the head space of the liquid container through the pressure regulating means. The slide 28 is formed so as to be capable of varying the area of an upper aperture 31 of the third gas channel 30, thereby adjusting the amount of the propellant gas flowing from the gas container into the liquid container. By adjusting the flow rate of the gas flowing through the third gas channel 30, the pressure of the propellant gas can be varied in the liquid container during dispensing. Since the pressure regulating means of the dispensing unit 10 is adapted to generate a predetermined pressure in the liquid container, the variable pressure range has an upper limit defined by said preset pressure of the pressure regulating means. On the other hand, the lower limit value of the variable pressure range can never decrease below the ambient pressure since the closure of the third gas channel 30 will terminate the outflow of the liquid and also prevent the ambient air from entering the liquid container.

The mechanism including the operating lever, the slide, the third channel and pressure regulating means together constitute a means for adjusting the flow rate of the propellant gas flowing from the gas container into the liquid container. By varying the flow area of the third gas channel by said mechanism, the desired pressure may be adjusted in the liquid container, and thereby the flow rate of the liquid may also be set during dispensing.

FIG. 7 schematically illustrates an assembled dispensing device 30 comprising a liquid container 36 (indicated by dashed line), for example, a bottle containing a beverage, a gas container 33 containing a propellant gas, for example carbon dioxide or nitrogen, at a high pressure, a dispensing unit, such as the dispensing unit 10 according to the present invention, and preferably a dip tube 35. The dispensing unit 10 is coupled to the liquid container 36 and the gas container 33 in a gas-tight sealed manner. Although in FIG. 7, the gas container 33 is shown inside the liquid container 36, the gas container 33 may equally be arranged externally to the liquid container 36. The dip tube 35 is arranged inside the liquid container 36 and connected to a corresponding dispensing channel of the dispensing unit 10.

In FIG. 8, a cross-sectional view of the dispensing device 30 shown in FIG. 7 is illustrated with the operating lever 14 of the dispensing unit 10 being in its initial position. The cross-section is taken along the line A-A of FIG. 2. In the dispensing device 30, the operating lever 14 is in its initial position that is normally applied during storage of the dispensing device 30. In this case, the front projection 18 of the operating lever 14 closes the outer end portion 19 of the dispensing tube 16, thereby preventing the dispensing of the liquid 32 from the liquid container 36. Due to the overpressure of the propellant gas 34 prevailing in the head space of the liquid container 36, the dispensing tube 16 also contains liquid 32 under pressure. The liquid 32 can enter the dispensing tube 16 through the opening 17 of the dispensing channel (not shown) formed within the dispensing unit 10.

In the partial cross-sectional view of FIG. 9, an exemplary way of coupling the dispensing unit 10 to the liquid container 36 and the gas container 33 can be seen in more detail. According the present invention, the dispensing unit 10 has a first coupling means for coupling to the liquid container 36. As illustrated in the embodiment shown in FIG. 9, the first coupling means may comprise a snap fitting portion 40 formed in the lower mounting part 11 of the dispensing unit 10, said snap fitting portion 40 being adapted to be sealingly attached to a corresponding coupling part of the liquid container 36. To this end, the first coupling means may comprise an elastic sealing ring 38 against which the corresponding coupling portion of the liquid container 36 bears after mounting the dispensing unit 10 onto the liquid container 36. Although in FIG. 9, only a preferred embodiment of said first coupling means is illustrated, the dispensing unit may according to the present invention may be coupled to the liquid container in other ways as well, for example by threaded fitting or gluing, the implementation of which alternative coupling modes is obvious for those skilled in the art.

According the present invention, the dispensing unit 10 further comprises a second coupling means for coupling to the gas container 33. As illustrated in the embodiment shown in FIG. 9, the second coupling means may comprise a snap fitting portion 42 formed also in the lower mounting part 11 of the dispensing unit 10, said snap fitting portion 42 being adapted to be sealingly attached to a corresponding coupling part of the gas container 33. It is preferred that the first coupling means comprises an elastic sealing ring 43 against which a corresponding coupling portion of the gas container 33 bears after attaching the gas container 33 to the dispensing unit 10. Although in FIG. 9, only a preferred embodiment of said second coupling means is illustrated, the dispensing unit may be coupled to the gas container in other ways as well, for example by threaded fitting or gluing, the implementation of which alternative coupling modes is obvious for those skilled in the art.

FIG. 9 shows the dispensing unit 10 in its storage state when the operating lever (not shown) is in its initial position. The slide 28 is now in its inner end position where it presses the whole coverage area of the membrane 22 onto an upper surface of the lower mounting part 11, thereby entirely closing the upper aperture 31 of the third gas channel 30. Under this condition, the membrane 22 takes the form like a dome, and the valve head 24 closes the lower aperture of the first gas channel 25a. The pressure of the propellant gas 34 acting to the bottom surface of the valve head 24 is compensated by the counteracting resilient force of the elevated membrane 22. In the gas space defined by the membrane 22 and the upper surface of the lower mounting part 11 of the dispensing unit 10, the pressure is equal to the pressure of the gas container 33, and due to the fluid communication path between the gas container 33 and the head space of the liquid container 36 through the second gas channel 25b, this pressure is also equal to the pressure prevailing in the liquid container 36, also referred to as a first pressure.

After finishing the dispensing of the liquid, the operating lever is moved again into its initial position, resulting in the same arrangement of the parts within the dispensing unit as shown in FIG. 9. If the dispensing pressure was lower than said first pressure when the dispensing was terminated, the propellant gas tends to flow from the gas container 33 into the liquid container 36 through the second gas channel 25b until the first pressure is reached and set in the liquid container 36 by the pressure regulating means of the dispensing unit 10.

In FIG. 10, the dispensing unit 10 can be seen with its operating lever 14 being in a vertical position wherein the dispensing tube 16 is open to the maximum extent, i.e. the outer end portion 19 of the dispensing tube 16 presents the largest possible flow area for the liquid. In this case, however, the third gas channel (not shown) is still closed. The liquid flows out from the liquid container 36 through the dispensing channel (not shown), then via the opening 17 and finally through the dispensing tube 16. If a dip tube 35 is also used (as shown in FIG. 10), the liquid 32 is driven into the dispensing channel through the dip tube 35.

FIG. 11 shows the same state of the dispensing unit 10 as shown FIG. 10, but in a cross-sectional view of the dispensing device 30 taken along the line H-H indicated in FIG. 2. The pressure regulating means is still under the same condition as described for the initial state of the dispensing unit 10, that is, the membrane 22 is elevated and the third gas channel 30 is closed. In the first preferred embodiment of the dispensing unit 10, this vertical operating position of the operating lever 14 shown in FIGS. 10 to 12 (also referred to as a first operating position) defines a boundary position between a first operating range of the operating lever 14 and a second operating range thereof, wherein the first operating range is associated with the control of the flow area of the dispensing channel or outlet for the liquid (i.e. the dispensing tube 16, in the first embodiment), whereas the second operating range is associated with the control of the flow area of the third gas channel 30 for the propellant gas. By continuing to pivot the operating lever 14 counter-clockwise in FIG. 11, the upper aperture 31 of the third gas channel 30 becomes gradually opened as the slide 28 moves toward the periphery of the lower mounting part 11.

As can be seen in the cross-sectional view of the dispensing device illustrated in FIG. 12, the dispensing channel 44 establishes a fluid communication path for the liquid 32 between the internal space of the liquid container 36 and the flexible tube 16. To the lower end of the dispensing channel 44, a dip tube 35 may optionally be connected.

In FIG. 13, the dispensing device 30 is shown in a partial cross-sectional view, wherein the operating lever 14 is moved to a second operating position to at least partially open the upper aperture 31 of the third gas channel 30. In the illustrated embodiment of the dispensing unit 10, this position of the operating lever 14 belongs to the second operating range of the operating lever 14, wherein the flow rate of the liquid 32 is controlled during dispensing by controlling the pressure of the propellant gas 34 in the liquid container 36. The more downward the operating lever 14 is pushed in the direction F indicated by an arrow in FIG. 13, the larger area of the upper aperture 31 of the third gas channel 30 is released by the displacement of the slide 28, thus causing the elevation of an increasing area of the coverage portion of the membrane 22 above the aperture 31. Hence, by varying the opened area of the aperture 31, the amount of gas flowing from the gas container 33 into the liquid container 36 through the third gas channel 30 and, consequently, the driving force for the liquid 32 may be varied.

In order to minimize or even entirely to terminate the gas flow through the second gas channel 25b during dispensing, the second gas channel 25b is to be closed or alternatively, it is to be restricted so that a substantial delay be presented at the generation of the first pressure in the liquid container 36 by the pressure regulating means. To this end, in the first preferred embodiment of the dispensing unit 10, the second gas channel 25b has a restricted section 25c in which the gas flow rate, under normal operating conditions, is so small that only a negligible amount of propellant gas can flow therethrough into the liquid container 36, and therefore the regulated first pressure can be generated by the pressure regulating means within a relatively long time with respect to the time period normally needed to dispense the desired amount of liquid. For example, if the first regulated pressure is 1.7-2 bars absolute, a diameter of approximately 100 urn for the restricted section 25c allows a regulation delay of approx. 5 to 15 minutes, which is a much longer time than the usual duration of filling a glass. After finishing the dispensing of the liquid, however, such a delay has no significance if the next dispensing action starts even later. Moreover, the regulated first pressure is in the liquid container 36 is greater than the equilibrium pressure of the liquid 32 stored in the liquid container 36, preferably only by a few tenths bar, thus providing an appropriate long term storage pressure for the liquid in the liquid container during storage.

On the other hand, the pressure regulating means of the first embodiment of the dispensing unit 10 also limits the maximum pressure of the pressure range associated with the second operating range of the operating lever. When the third gas channel 30 is entirely opened, the pressure in the liquid container 36 increases quickly due to the large flow are of the aperture 31, but the pressure can rise only up to the first pressure since the pressure regulating means prevents the pressure of the head space of the liquid container 36 from increasing further. In fact, upon reaching the first pressure in the liquid container 36, the valve head 24 will close the first gas channel 25a, thereby blocking the flow of any more propellant gas 34 from the gas container 33 into the liquid container 36.

In FIG. 14, a partial cross-sectional view of a dispensing device 30′ is illustrated with a second embodiment of the dispensing unit 110 according to the present invention. In this example, the operating lever 114 (indicated by dashed line) of the dispensing unit 110 is in its initial position used for storage of the liquid container 136. This second embodiment of the dispensing unit 110 comprises a common gas channel 130 providing the function of both the first gas channel and the second gas channel used in the first embodiment of the dispensing unit. In order to properly control the gas flow through this common gas channel 130, the slide 128 is designed to have a recess 129 on its bottom sliding surface which allows the membrane 122 to have a local elevation 123 above the upper aperture 131 of the common gas channel 130. Under this local elevation 123, a limited flow rate for the propellant gas 134 is allowed, thus providing a substantial delay in the development of the first pressure in the liquid container 136.

As can be seen in FIG. 15, which illustrates the second embodiment of the dispensing unit 110 with the operating lever 114 being in its first operating position, the slide 128 is moved to a position where it entirely closes the common gas channel 130. Similarly to the first embodiment of the dispensing unit (but not shown in FIG. 15), in this position the operating lever 114 entirely opens the flexible dispensing tube of the dispensing unit 110.

FIG. 16 illustrates the second embodiment of the dispensing unit 110 with the operating lever 114 being in a second operating position during dispensing where the inner end portion of the slide 128 at least partly opens the common gas channel 130 by allowing the main part of the membrane 122 to elevate above the upper aperture 131 of the common gas channel 130. In the second operating range of the operating lever 114, the common gas channel 130 is used only for controlling the pressure of the propellant gas in the liquid container 136 and thus also the flow rate of the liquid being dispensed. As the second embodiment of the dispensing unit 110 has no separate gas channel with a restricted section to feed propellant gas 134 from the gas container 133 into the liquid container 136, the relatively large flow area of the common gas channel 130 allows a rather quick development of the regulated first pressure in the liquid container 136 after finishing the dispensing of the liquid.

In a second aspect, the present invention also relates to a novel method of dispensing a liquid under pressure from a liquid container in which the liquid is stored under pressure by a propellant gas having at a first regulated pressure. Preferably, the first pressure exceeds the equilibrium pressure of the liquid by a few tenths bar. So as to provide the first regulated pressure in the liquid container, additional propellant gas is stored in a gas container at a second pressure substantially higher than the first pressure. The propellant gas stored in the second gas container is also used for controlling the flow rate of the liquid during dispensing.

In the method according to the invention, the dispensing is started by reducing the first pressure of the liquid container to a third pressure, wherein the third pressure is at least the ambient pressure. Depending on the design of the particular dispensing apparatus used for dispensing, the third pressure may be higher than the ambient pressure. After the overpressure of the liquid container is partly or wholly released, the dispensing path for the liquid is opened and the flow area of the entire dispensing path is settled. Opening of the dispensing path of the liquid may be carried out along an internal dispensing duct or at a dispensing outlet.

Finally, while keeping the settled flow area of the dispensing path for the liquid unchanged, the pressure of the propellant gas in the liquid container is controlled within a pressure range defined by the first pressure and the ambient pressure, thereby dispensing a first amount of liquid. This first amount preferably corresponds to the entire dose of the liquid to be dispensed at one run. It is preferred that the overpressure prevailing in the liquid container during dispensing does not exceed the ambient pressure by a few tenths bar, e.g. 0.1-0.2 bar, in order keep the flowing rate of the liquid at a rather low level and thereby not to allow excess frothing of the liquid.

Alternatively, the step of reducing the overpressure in the liquid container and the step of opening and settling the flow area of the dispensing path for the liquid may be executed simultaneously. In this case a second amount of liquid may additionally be dispensed in this step, but this second dispensed amount of liquid should be very limited. It is preferred that the second amount is smaller than 10 to 15% of the entire amount of liquid to be dispensed in one dose.

In a particularly preferred embodiment of the method according to the present invention, during dispensing, the dispensing pressure of the propellant gas in the liquid container is controlled by controlling the flow rate of the propellant gas flowing from the gas container into the liquid container. For controlling the pressure in the liquid container during dispensing may, however, be carried out in other ways as well, for example by using an additional gas supply, optionally an external gas container, to provide the necessary amount of gas for this purpose.

Although in the foregoing, several preferred embodiments of the dispensing unit and the dispensing method according to the invention have been illustrated, the present invention is not in any way limited to the exemplary embodiments shown in the description and the drawings and many variations thereof are possible within the scope of the invention defined by the attached claims.

In particular, the single operating lever of the dispensing unit may be carried out by providing two independent operating levers for each operating range mentioned above, i.e. a first operating lever for controlling the flow area of the dispensing path for the liquid and a second operating lever for controlling the flow are of the third gas channel (or the common gas channel) for the propellant gas. Moreover, instead of levers, any other kind of tool, such as a push button, a rotatable knob, etc. may be used as an operating means for controlling the flow rate of the liquid.

The pressure regulating means may also be designed differently from the exemplary pressure regulator described above with reference to the drawings, while providing the same function of generating a regulated first pressure in the liquid container. Such pressure regulating means are well-known in the art.

1. A dispensing unit for dispensing a liquid under pressure, the dispensing unit comprising
a first coupling means for coupling to a liquid container adapted to store the liquid to be dispensed and a propellant gas at a first pressure,
a pressure regulating means for generating said first pressure in the liquid container, the pressure regulating means having
a second coupling means for coupling to a gas container adapted to store said propellant gas at a second pressure substantially higher than said first pressure,
a first fluid communication path for the propellant gas between said gas container and said liquid container,
a dispensing path for dispensing the liquid from the liquid container,
a first operating means for controlling the flow rate of the liquid along the liquid dispensing path during dispensing,
characterized by that
the dispensing unit further comprises a second operating means for controlling, during dispensing, the pressure of the liquid container within a range defined by the first pressure and a third pressure lower than the first pressure.

2. The dispensing unit according to claim 1, wherein the second operating means is adapted to control the flow rate of the propellant gas flowing from the gas container into the liquid container.

3. The dispensing unit according to claim 1, wherein
the dispensing unit further comprises a second fluid communication path for the propellant gas between said gas container and said liquid container,
the second operating means is adapted to control the flow rate of the propellant gas flowing through said second fluid communication path from the gas container into the liquid container, and
said first fluid communication path being adapted to provide a substantial delay in generating the first pressure in the liquid container.

4. The dispensing unit according to claim 3, wherein first fluid communication path is formed so as to provide at least a few minute delay in the generation of the first pressure in the liquid container.

5. The dispensing unit according to claim 1, wherein the first operating means and the second operating means are integrated into a single control mechanism having a first operating range to provide the function of the first operating means and a second operating range to provide the function of the second operating means.

6. The dispensing unit according to claim 1, wherein the first pressure is 1.6 to 1.8 bar absolute.

7. The dispensing unit according to claim 1, wherein the first pressure is 1.05 to 1.2 bar absolute.

8. The dispensing unit according to claim 1, wherein the second pressure is 8 to 10 bars absolute.

9. The dispensing unit according to claim 1, wherein the third pressure is approximately the ambient pressure.

10. The dispensing unit according to claim 1, wherein the dispensing unit is provided with a dip tube connected to the inner end of said liquid dispensing path opening into the liquid container.

11. The dispensing unit according to claim 1, wherein the external end portion of the dispensing path is formed by a flexible tube and the first operating means is adapted to control the flow rate of the liquid by adjusting the flow area of the flexible tube by the compression thereof.

12. A method for dispensing a liquid under pressure, wherein the liquid is stored in a liquid container with a propellant gas at a first regulated pressure, and additional propellant gas is stored in a gas container at a second pressure substantially higher than the first pressure, and the liquid is dispensed by means of a dispensing unit coupled to said liquid container and said gas container, the method comprising the steps of:
a) reducing the first pressure of the liquid container to a third pressure, wherein the third pressure is at least the ambient pressure,
b) opening a liquid dispensing path of the dispensing unit and settling the flow area of said liquid dispensing path, and
c) while keeping the adjusted flow area of the liquid dispensing path unchanged, controlling the dispensing pressure of the propellant gas in the liquid container within a pressure range defined by the first pressure and the ambient pressure, thereby dispensing a first amount of liquid.

13. The method of dispensing a liquid according to claim 12, wherein the dispensing pressure of the propellant gas in the liquid container is controlled by controlling the flow rate of the propellant gas flowing from the gas container into the liquid container.

14. The method of dispensing a liquid according to claim 13, wherein the step of reducing the first pressure to the third pressure and the step of opening the liquid dispensing path are performed simultaneously, thereby dispensing a second amount of liquid, said second amount being substantially less than said first amount.
